(19) United States
(12) Patent Application Publication
(10) Pub. No.: US 2024/0349275 A1
(43) Pub. Date: Oct. 17, 2024

(54) LOGICAL CHANNEL PRIORITIZATION FOR MULTI-PHYSICAL UPLINK SHARED CHANNEL GRANT

(71) Applicant: Apple Inc., Cupertino, CA (US)

(72) Inventors: Ping-Heng Kuo, London (GB); Fangli Xu, Beijing (CN); Ralf Rossbach, Munich (DE); Naveen Kumar R. Palle Venkata, San Diego, CA (US); Zhibin Wu, Los Altos, CA (US); Peng Cheng, Beijing (CN); Sethuraman Gurumoorthy, San Ramon, CA (US)

(73) Assignee: Apple Inc., Cupertino, CA (US)

(21) Appl. No.: 18/592,331

(22) Filed: Feb. 29, 2024

Related U.S. Application Data
(60) Provisional application No. 63/459,848, filed on Apr. 17, 2023.

(51) Int. Cl. H04W 72/1268; H04W 72/566; H04W 76/20; H04W 80/02

(52) U.S. Cl. CPC H04W 72/1268; H04W 72/566; H04W 76/20; H04W 80/02

(57) ABSTRACT

Techniques for flexible hybrid automatic repeat request selection by a user equipment are provided. An example method includes a user equipment (UE) processing a plurality of physical uplink shared channel (PUSCH) opportunities associated with a configured grant (CG) cycle. The UE can apply a first logical channel prioritization (LCP) setting when processing a first PUSCH opportunity of the plurality of PUSCH opportunities. The UE can evaluate whether a condition for switching from the first LCP to a second LCP of the plurality of PUSCH opportunities has been met. The UE can, based on the evaluation, apply a second LCP setting when processing the second PUSCH opportunity.

### CROSS-REFERENCES TO RELATED APPLICATIONS

This application claims the benefit of U.S. Provisional Application No. 63/459,848, filed on Apr. 17, 2023, which is incorporated by reference.

### BACKGROUND

Cellular communications can be defined in various standards to enable communications between a user equipment and a cellular network. For example, long-term evolution (LTE) and Fifth generation (5G) networks are defined by wireless standards that aim to improve upon data transmission speed, reliability, availability, and more.

### BRIEF DESCRIPTION OF THE DRAWINGS

FIG. 1 is an illustration of a system for providing content to a user equipment (UE), according to one or more embodiments.

FIG. 2 is an illustration of a payload periodic traffic pattern, according to one or more embodiments.

FIG. 3 is an illustration of a periodic configured grant (CG) configuration, according to one or more embodiments.

FIG. 4 is an illustration of varying data packets sizes, according to one or more embodiments.

FIG. 5 is an illustration of multi-physical uplink secure channel (PUSCH) opportunities, according to one or more embodiments.

FIG. 6 is an illustration describing used and unused PUSCH opportunities, according to one or more embodiments.

FIG. 7 is an illustration of an adaptive logical channel prioritization (LCP) setting, according to one or more embodiments.

FIG. 8 is a logical flow for a UE selecting an LCP setting, according to one or more embodiments.

FIG. 9 is a process flow for a UE selecting an LCP setting, according to one or more embodiments.

FIG. 10 is a process flow for a UE selecting an LCP setting, according to one or more embodiments.

FIG. 11 is a process flow for a UE selecting an LCP setting, according to one or more embodiments.

FIG. 12 illustrates an example of receive components, in accordance with some embodiments.

FIG. 13 illustrates an example of a user equipment (UE), in accordance with some embodiments.

FIG. 14 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, and/or 6G. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted.” Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

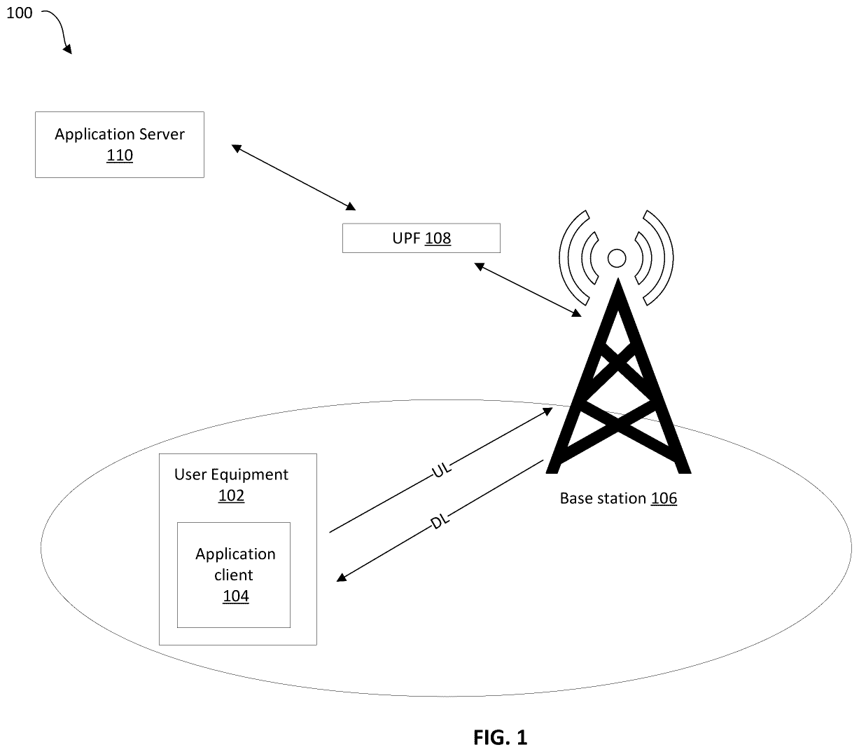

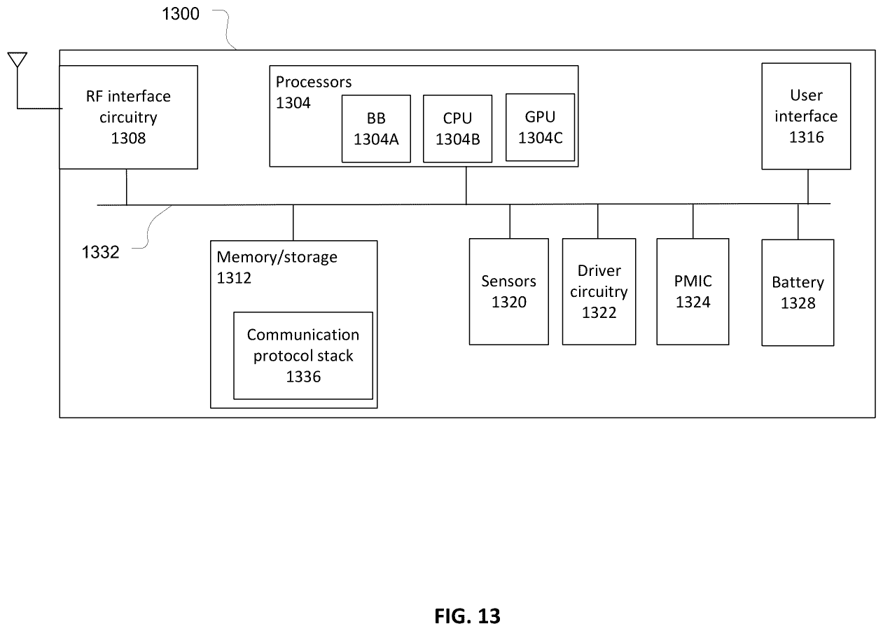

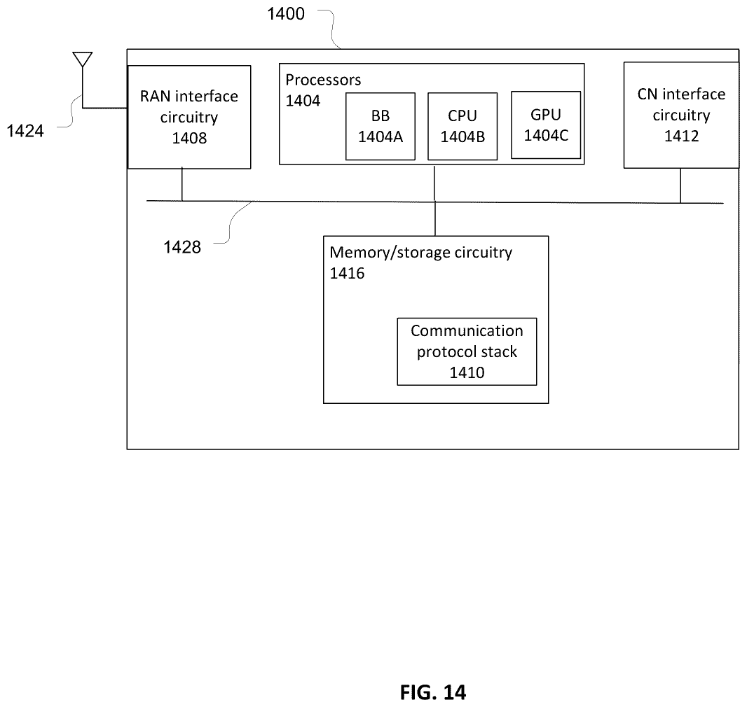

FIG. 1 is an illustration of a system for uploading content from a user equipment (UE), according to one or more embodiments. As illustrated, a UE 102 can include an application client 104 for providing a user with an experience. The UE 102 can be, for example, the UE 1300 described in FIG. 13. For example, the user can use the application client 104 to transmit (e.g., uplink (UL) communication) and receive (e.g., downlink (DL) communication) content and present the content on the UE 102. The UE 102 can be camped in a cell provided by a base station 106. The base station 106 can be, for example, the base station 1400 as described in FIG. 14. The base station 106 can, for example, use a user plane function (UPF) 108 to communicate with an external data network, such as one that includes an application server 110. The UE 102 can exchange information with the application server 110 to provide a user with an experience.

The base station 106 can configure the UE 102 with uplink transmission parameters to transmit data to the base station 106. Through the configuration, the UE 102 is allocated resources for periodic physical uplink shared channel (PUSCH) opportunities, in which the UE can transmit multiple PUSCH transmissions in each configured grant (CG) cycle. For example, the UE 102 can be configured to transmit x-number of PUSCH transmissions in each CG cycle.

Certain data traffic patterns can include variations in data packet sizes based on the technology and the type of data that is being transmitted. One example of technology that results in variations in data packet sizes is extended reality (XR). Certain XR technology is based on overlaying graphics on an image which may be performed using smaller packets. On the other hand, an immersive XR experience can use high resolution graphics and location data, which requires larger packets.

Given the different data packet sizes, it is possible that the UE 102 uses all of the PUSCH opportunities in a CG cycle. However, in other instances, the UE can only use a portion of the PUSCH opportunities in the CG cycle. In these instances, some PUSCH opportunities can be unused. Therefore, it would be beneficial if the UE 102 can flexibly select parameters and use these spare PUSCH opportunities for other purposes during the CG cycle.

It should be appreciated that XR technology is illustrated as an example of a technology that can result in data traffic patterns that include varying data packet sizes. Those having ordinary skill in the art can contemplate various technologies that can result in data traffic patterns that include varying data packet sizes.

The herein-described embodiments address the above-referenced issues by providing technologies to allow the UE 102 to adapt the logical channel prioritization (LCP) settings to use spare PUSCH opportunities for purposes other than intended for by the CG. A plurality of PUSCH opportunities can be partitioned into a first subset and a second subset, wherein the first subset includes the PUSCH opportunities to be used to transmit data based on the original purpose (e.g., to perform new transmission for data from specific logical channels (LCHs), this can be enabled by LCH mapping restriction with allowed CG). The LCP setting for the PUSCH opportunities of the first subset can be set by the base station 106. The second subset can include PUSCH opportunities to be used for alternative purposes, such as performing a retransmission of a previously transmitted transport block (TB), performing an autonomous transmission of a previously de-prioritized TB, or performing a new initial transmission. To allow the UE 102 to use the second subset for alternative purposes, the UE 102 can be enabled to adapt the LCP settings for the PUSCH opportunities of the second subset.

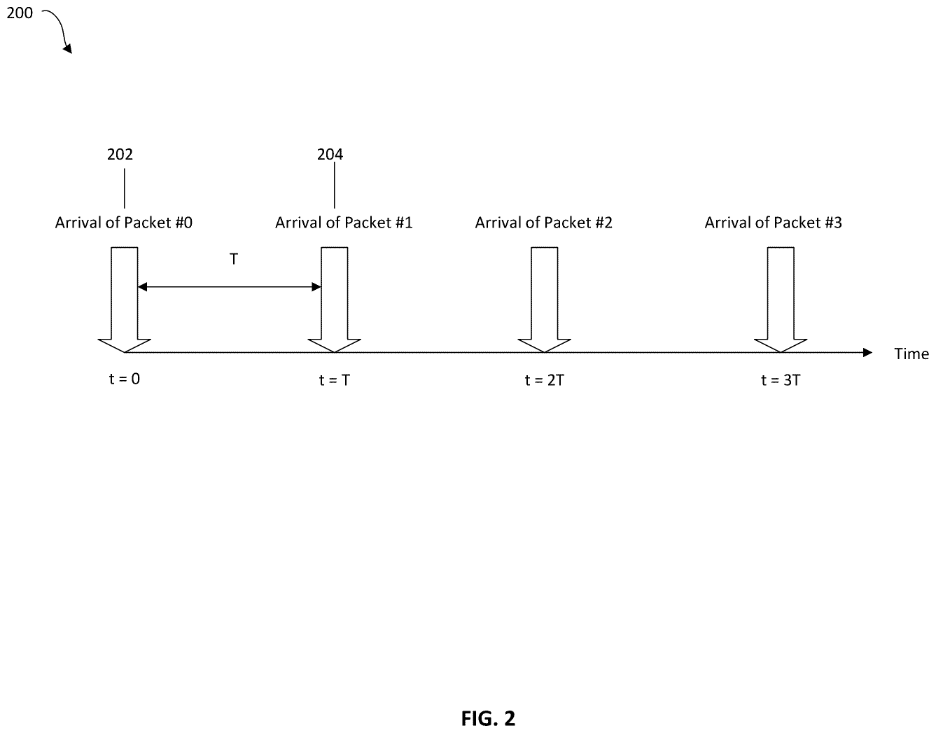

FIG. 2 is an illustration of a payload periodic traffic pattern, according to one or more embodiments. For both the DL transmission and the UL transmission of some services, the payload is periodical. For example, in XR service, the video frame rate can be 30 frames per second, 60 frames per second, or 90 frames per second. As illustrated, the arrival of each packet is periodical, in which each period can be defined by the frequency 1/T. The arrival of a first packet 202 can be followed by the arrival of a second packet 204, and so on. The arrival time of each packet is separated by time period T.

In an ideal situation, the radio access network (RAN) can obtain assistance information relating to the characteristics of the data traffic from either the core network or the UE. The RAN could further use such assistance information to appropriately allocate resources for XR services. Based on the periodic nature of the data traffic, the CG can be expected to be a key resource allocation method for new transmission of data of specific UL traffic flow. However, as indicated above, in some instances, resources are allocated for PUSCH opportunities that are unused for new transmission for specific UL traffic flow, but could be used for alternative purposes.

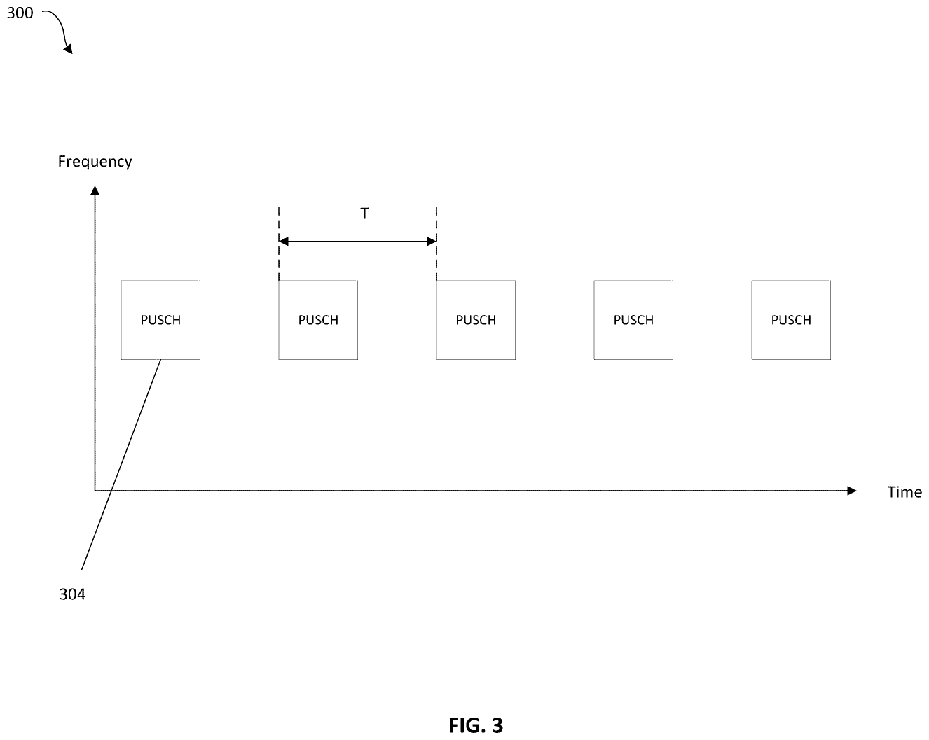

FIG. 3 is an illustration 300 of a periodic CG configuration, according to one or more embodiments. The CG permits the UE to know in advance where, in the time and frequency range, that the PUSCH resources are available for an UL transmission, without the need for dynamic signaling for resource allocation. As illustrated, a CG configuration with a periodicity of T is shown. For each PUSCH opportunity 304, the UE (e.g., UE 102) can receive information from the network configurations for the resources that are allocated for a UL transmission during the PUSCH opportunity. As further illustrated, the CG is used to allocate resources for each PUSCH opportunity per CG cycle, where each CG cycle can be defined by a time period T.

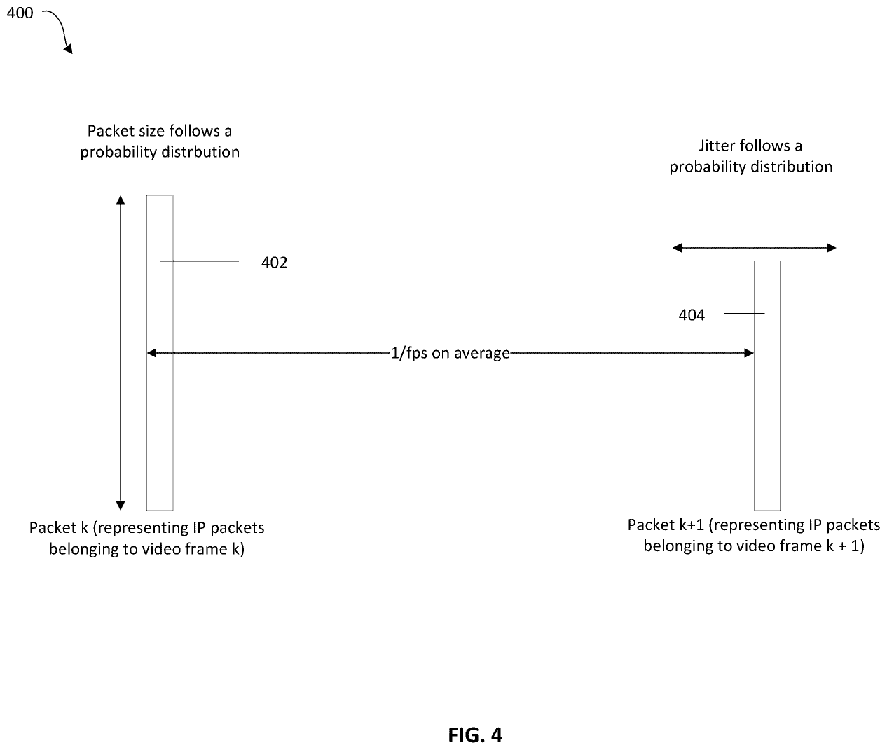

FIG. 4 is an illustration of varying data packet sizes, according to one or more embodiments. As illustrated, a packet k 402 is followed by a packet k+1. Packet k 402 represents internet protocol (IP) packets belonging to video frame k and packet k+1 404 represents IP packets belonging to video frame k+1. According to 3^{rd} Generation Partnership Project (3GPP) Technical Report (TR) 38.838 V17.0.0 (2021-12), periodic traffic can be associated with random jitter, where the actual arrival time may be offset from the nominal timing, based on traffic periodicity. As illustrated, the data traffic packets can be transmitted at 1 frame per second (fps) on average based on an expected jitter. In addition to variations in timing, there are variations in packet size. As illustrated, packet k 402 is larger than packet k+1 404. It is possible that the traffic characteristics will be addressed in release-18. There can be different situations involving varying packet sizes with a fixed transport block size (TBS). A first situation can be when the packet size is larger than the TBS of a CGS occasion. Therefore, the packet cannot be accommodated with one CG cycle, which can cause latency. The second situation can be when the packet size is smaller than the TBS of CG occasion, which is not resource efficient. Furthermore, in this second situation, the base station could have allocated resources to another UE.

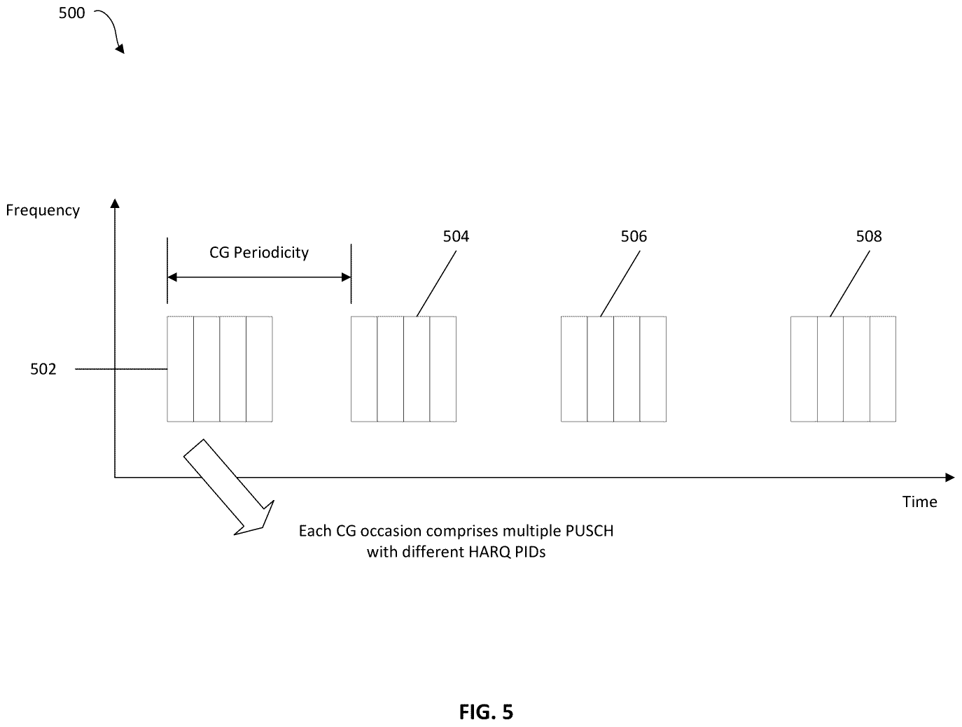

FIG. 5 is an illustration 500 of multi-PUSCH opportunities, according to one or more embodiments. As illustrated, each CG occasion includes a plurality of multi-PUSCH opportunities, in which each set includes four PUSCH opportunities. It can be seen that each of the first plurality of PUSCH opportunities 502, the second plurality of PUSCH opportunities 504, the third plurality of PUSCH opportunities 506, and the fourth plurality of PUSCH opportunities 508 includes four PUSCH opportunities. The periodicity of each plurality of PUSCH opportunities in a CG occasion extends from the beginning of a first PUSCH opportunities of the first plurality of PUSCH opportunities 502 to the beginning of a first PUSCH opportunities of the second plurality of PUSCH opportunities 504. As described herein, multi-PUSCH opportunities indicate more than one PUSCH opportunity.

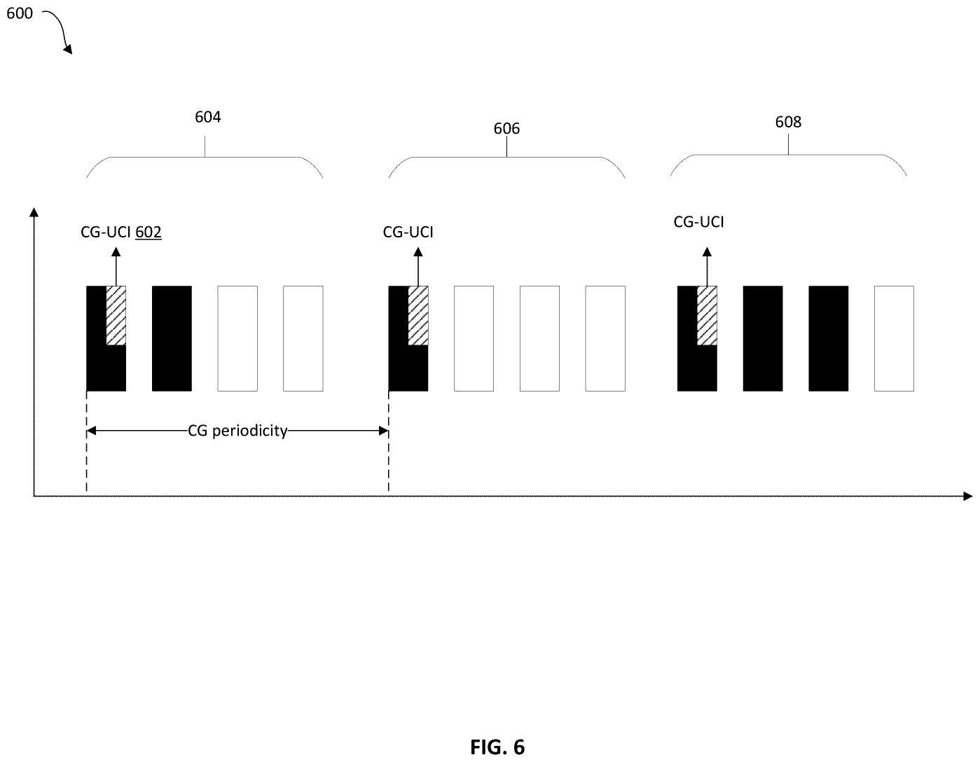

FIG. 6 is an illustration 600 describing used and unused PUSCH opportunities, according to one or more embodiments. As indicated above, in certain instances, the UE's uplink data traffic includes varying packet sizes, and therefore, the UE does not need to use every single PUSCH opportunity in a CG cycle. In these instances, there will be unused PUSCH opportunities or spare PUSCH opportunities. In release-18, the UE can send an indication (e.g., in CG-UCI) 602 to a base station as to which PUSCH opportunities that are not to be used, and therefore the base station can allocate the resources allocated for those PUSCH opportunities to other UEs. As illustrated, for each plurality of PUSCH opportunities, there can be a different number of used and unused PUSCH opportunities. In the first plurality of PUSCH opportunities 604, there are two used PUSCH opportunities (illustrated in black) and two unused PUSCH opportunities (illustrated in white). In the second plurality of PUSCH opportunities 606, there is one used PUSCH opportunity and three unused PUSCH opportunities. In the third plurality of PUSCH opportunities 608, there are three used PUSCH opportunities and one unused PUSCH opportunity.

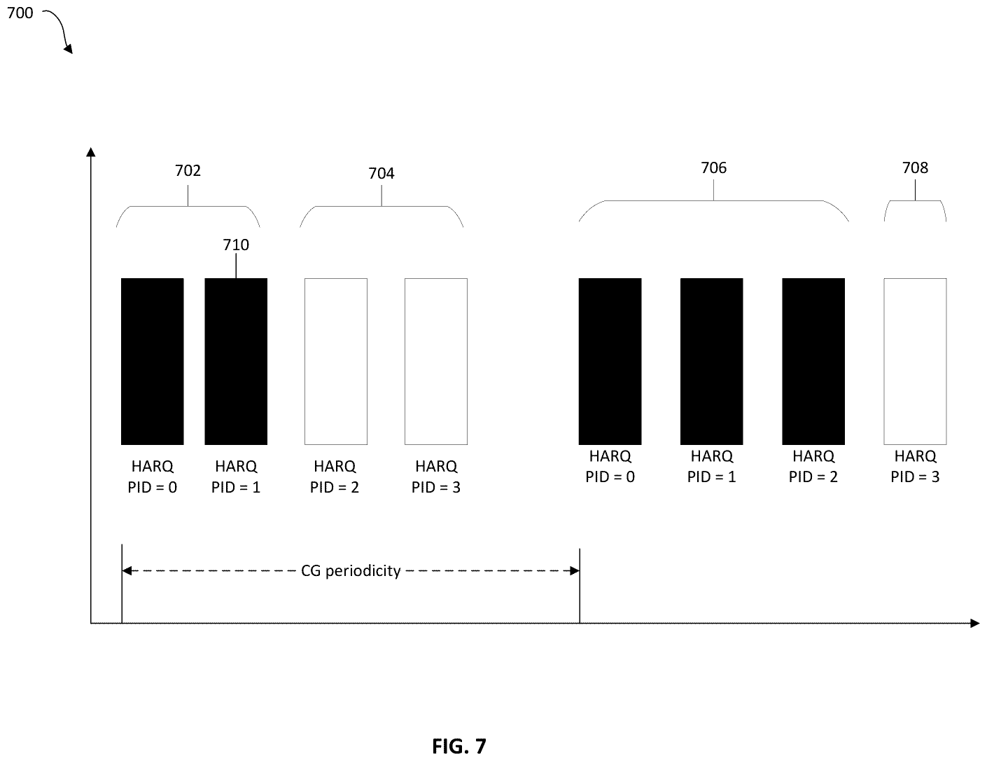

FIG. 7 is an illustration 700 of an adaptive logical channel prioritization (LCP) setting, according to one or more embodiments. Embodiments describe a methodology for enabling a UE to use a spare PUSCH resource associated with a multi-PUSCH CG cycle and improve resource efficiency. A base station can use CG configuration to allocate resources for N number of PUSCH opportunities in a CG cycle. The UE can further set a different logical channel prioritization (LCP) setting for the different subsets of the PUSCH opportunities. An LCP setting can include at least one of the following: (1) a mapping restriction of at least one LCH to a specific transport channel, (2) a priority of an LCH transmission, (3) prioritized bit rate (PBR) of at least one LCH (e.g., a maximum bit rate for at least one LCH), and (4) bucket size duration (BSD) of at least on LCH.

As illustrated, a plurality of N PUSCH opportunities in a CG cycle can be partitioned into a first subset 702 and a second subset 704. The first subset 702 can include K (K<N) PUSCH opportunities whose LCP has been fixed by a base station. The second subset 704 of PUSCH opportunities can include N-K PUSCH opportunities, in which the UE has selected the LCP setting. In this sense, the UE can use the PUSCH opportunities in the second subset 704 to transmit data that does not meet a default mapping restriction. By allowing the UE to adapt the LCP setting, the UE can use spare PUSCH opportunities in the second subset 704 for a different purpose than the PUSCH opportunities in the first subset 702. It should be appreciated that other types of LCH mapping restrictions are not precluded.

A logical channel mapping restriction (LCMR) can include a set of rules for limiting the mapping of a logical channel to a transport channel. According to 3GPP Technical Standard T.S. 38.321 17.4.0 (2023-03), an LCH can be configured using radio resource control (RRC) parameters for LCH mapping restriction rules (e.g., the data from the LCH can only be multiplexed into UL resources satisfying the specified criteria. Examples of RRC parameters include allowedSCS-List which sets the allowed Subcarrier Spacing(s) (SCSs) for transmission; maxPUSCH-Duration which sets the maximum PUSCH duration allowed for transmission configuredGrantType1Allowed which sets whether a configured grant Type 1 can be used for transmission; allowedServingCells which sets the allowed cell(s) for transmission; allowedCG-List which sets the allowed configured grant(s) for transmission; allowedPHY-PriorityIndex which sets the allowed PHY priority index(es) of a dynamic grant for transmission; and allowedHARQ-mode which sets the allowed HARQ mode for transmission.

As illustrated, the first subset 702 includes two PUSCH opportunities and the second subset 704 includes one PUSCH opportunity. The two PUSCH opportunities of the first subset 702 have been set with a first LCP setting and the UE has applied the second LCP setting for the two PUSCH opportunities of the second subset 704. For example, a base station can have configured the UE with the first LCP setting and the second LCP setting.

It can further be seen that the subsets do not necessarily include an even distribution of PUSCH opportunities. Another plurality of PUSCH opportunities includes a third subset 706 of three PUSCH opportunities and a fourth subset 708 with one PUSCH opportunity. The three PUSCH opportunities of the third subset 706 have been set with a first LCP setting and the UE has applied the second LCP setting for the one PUSCH opportunity of the fourth subset 708. It should be appreciated that the herein described embodiments are applicable to CGs and multi-PUSCH dynamic grants (DGs). It should further be appreciated that although only two LCP setting have been illustrated, one of ordinary skill in the art can contemplate that there can be a number of LCP settings is greater than one.

The following examples of different LCP setting are provided using FIG. 7, where the PUSCH opportunities shown in FIG. 7 are pertaining to configured grant configuration CG #X. In a first example, the PUSCH opportunities in the first subset 702 are associated with a first LCP setting, in which only LCH #X is permitted to be mapped to CG #X. Furthermore, other LCHs are not permitted to be mapped to CG #X. Therefore, only data from LCH #X can be transmitted using PUSCH opportunities in the first subset 702. The PUSCH opportunities in the second subset 704 are used by the UE based on a second LCP setting, in which both LCH #X and LCH #Y are permitted to be mapped to CG #X. Other LCHs are not permitted to be mapped to CG #X. Therefore, only data from LCH #X and LCH #Y can be transmitted using PUSCH opportunities in the second subset 704.

In a second example, the PUSCH opportunities in the first subset 702 at set at a first LCP setting, in which only LCH #X is permitted to be mapped to CG #X and other LCHs are not permitted to be mapped to CG #X. Therefore, only data from LCH #X can be transmitted using PUSCH opportunities in the first subset 702. The PUSCH opportunities in the second subset 704 are used by the UE based on a second LCP setting, in which all LCHs are permitted to be mapped to CG #X. Therefore, data from any LCH can be transmitted using PUSCH opportunities in the second subset 704.

In a third example, the PUSCH opportunities in the first subset 702 at set at a first LCP setting, in which a priority of LCH #X is deemed to be higher than a priority of LCH #Y, when MAC PDUs are generated for the PUSCH opportunities in the first subset 702. The PUSCH opportunities in the second subset 704 are used by the UE based on a second LCP setting, in which in which a priority of LCH #Y is deemed to be higher than a priority of LCH #X, when MAC PDUs are generated for the PUSCH opportunities in the second subset 704.

In some embodiments, LCH #X can be mapped to the CG, whereas LCH #Y is not allowed to be mapped to the CG. For example, for LCH #X, a UE can transmit the data from LCH #X using any PUSCH opportunity associated with a CG configuration. Additionally, for LCH #Y, by default the UE is not allowed to transmit data from LCH #Y using any PUSCH opportunity associated with the CG configuration, except for the spare PUSCH opportunity associated with the CG configuration. For example, for LCH #Y, the UE can transmit data from LCH #Y using PUSCH opportunity associated with a CG cycle of the CG configuration, if the UE determines that a triggering condition has occurred (e.g., a buffer of LCH #X is empty). In some embodiments, the UE may further determine if data from LCH #Y can be transmitted using spare PUSCH opportunity associated with the CG configuration by additionally evaluate if one of the following conditions is also met (1) the UE determines that the parameters associated with the PUSCH resources (e.g., subcarrier spacing, PUSCH duration, hybrid automatic repeat request (HARQ)) setting satisfy specific conditions (e.g., the parameters satisfy the LCP mapping restrictions configured for LCH #Y); or (2) the LCH is configured to allow the UE to transmit data from the LCH on any or specific unused/spare PUSCHs opportunity regardless of the PUSCH parameters (e.g. a parameter is configured for LCH #Y indicating that data from LCH #Y can be mapped to unused/spare PUSCHs of a particular CG configuration).

As seen in FIG. 7, the UE can switch the LCP setting of the PUSCH opportunities in the first subset after the second PUSCH opportunity 710 in the first subset 702. The UE can use various information to determine whether to switch an LCP setting for a PUSCH opportunity associated with a CG cycle with multi-PUSCH opportunities.

In some instances, a base station can configure the UE to use the first LCP setting for the first subset 702 and use the second LCP setting for second subset 704. In these instances, the UE's decision to switch LCP setting is based on the configuration by the base station.

In other instances, the UE determines whether to switch an LCP settings for a PUSCH opportunity associated with a CG cycle with multi-PUSCH opportunities based on one or more triggering conditions. A first triggering condition can include the buffer of one or more LCHs becoming empty. A second triggering condition can include the buffer of one or more LCHs becoming empty for a period of time. For example, the triggering condition can be that the buffer remains empty over a threshold period of time. A third triggering condition can be that the buffer of one or more LCHs receives data. For example, the triggering condition can be that a buffer of a designated LCH receives data. A fourth triggering condition can be that the data loaded of a buffer of one or more LCHs is less than a first threshold amount of data. The UE can be configured with the first threshold by the network A fifth triggering condition can be that the data loaded of a buffer of one or more LCHs is greater than a second threshold amount of data. The UE can be configured with the second threshold by the network.

A sixth triggering condition can be that a time interval between a current time and a data delivery deadline time is smaller than a third threshold amount of time. The UE can be configured with the third threshold by the network. A seventh triggering condition can be that the data queuing time has exceeded a fourth threshold amount of time. For example, the triggering condition can be that data loaded onto a buffer has remained in the buffer for greater than the fourth threshold amount of time. The UE can be configured with the fourth threshold by the network.

An eighth triggering condition can be that at least one data unit loaded on the buffer of one or more LCHs is an important protocol data unit (PDU). For example, a new radio packet data convergence protocol (PDCP) PDU can be considered important as it is used to transmit user data between the UE and the base station and is responsible for the confidentiality of the transmission. A ninth triggering condition can be that no data unit loaded on the buffer of one or more LCHs is an important PDU. A tenth triggering condition can be that link between the UE and the base station or the network as a whole is congested. A link or the network can be congested if the demand for resources on the link or network exceeds the supply of an available resource.

Regardless of the triggering condition, the determination of whether the triggering condition has occurred can be performed prior to generation of a medium access control (MAC) protocol data unit (PDU) to be transmitted using a PUSCH opportunity.

After switching the LCP from one setting to another setting, the UE can be configured to exhibit a behavior. For example, the network can configure the UE to exhibit the behavior. In one instance, after a first switch from a default LCP setting to a different LCP setting, the UE can switch back to the default LCP setting. For example, after using the spare PUSCH opportunities, the UE can switch back to the default LCP setting for at least the first PUSCH opportunity associated with the next CG cycle. In another example, after using one or more spare PUSCH opportunities, the UE can switch back to the default LCP setting PUSCH opportunity for any remaining spare PUSCH opportunities associated with the same CG cycle. This can occur in the instance that the UE no longer needs to transmit data using the different LCP setting and there are spare PUSCH opportunities remaining and associated with the CG cycle.

In another instance, the UE can switch from a default LCP setting to a different LCP setting and keep using the different LCP for any remaining spare PUSCH opportunities in a current CG cycle and any subsequent CG cycles until a condition is met. The condition can include, for example, receiving an implicit or explicit indication from the network to switch the LCP setting. Another indication can be the expiration of a timer associated with the different LCP setting.

In some instances, the UE can provide assistance information to the network or transmit a message to the network indicating a preference for switching from a first LCP setting to a second LCP setting. The assistance information can be transmitted using RRC messaging and include a UE internal status to the network to permit the network to better allocate resources for the UE. The assistance information can also be transmitted in a new type of medium access control control element (MAC CE) or an extension of an existing MAC CE, such as buffer status reporting (BSR).

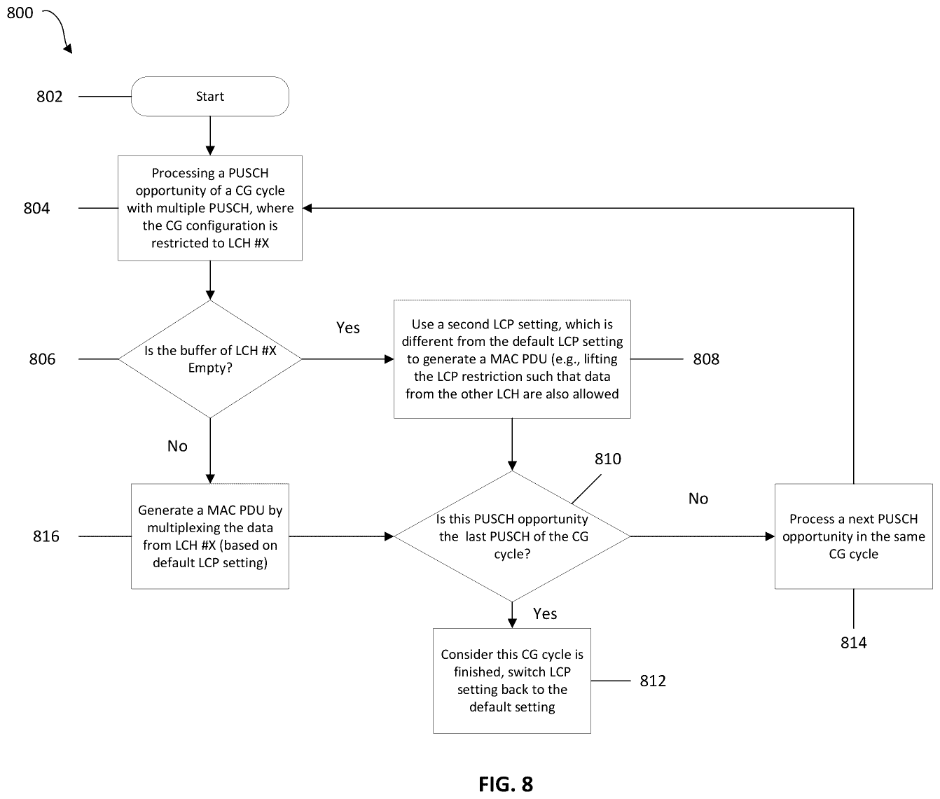

FIG. 8 is a logical flow for a UE applying an LCP setting, according to one or more embodiments. At 802, a process can begin, for example, by a UE processing a plurality of PUSCH opportunities associated with a CG cycle. At 804, the UE can process a PUSCH opportunity of the CG cycle, in which the LCP setting is a default setting. The default LCP setting can by that only LCH #X is permitted to be mapped to the CG. In response, the core network can send a message to the UE indicating whether the UE can enable LCP setting switching. For example, the core network can transmit an explicit control signal (e.g., “option 1” for LCP setting switching).

At 806, the UE can determine whether the buffer of LCH #X is empty. Although FIG. 8 describes the triggering condition as the buffer of LCH #X being empty, step 806 can include any of the above described triggering conditions.

If the buffer of LCH #X is empty, the process can proceed to step 808. At 808, the UE can apply a second LCP setting for a PUSCH opportunity. The second LCP setting can be different than the default LCP setting. The second LCP setting can, for example, that any LCH can be permitted to be mapped to the CG. The UE can further create a MAC PDU using data of another LCH than LCH #X. The UE can further transmit the MAC PDU using the PUSCH opportunity.

At 810, the UE can determine whether the PUSCH opportunity used in step 808 is the last PUSCH opportunity associated with the CG cycle. In other words, the UE can determine whether there are any additional spare PUSCH opportunities. If the PUSCH opportunity is the last PUSCH opportunity associated with the CG cycle, the process can process to 812.

At 812, the UE can consider this CG cycle finished and switch the LCP setting back to the default setting. However, as described above, the UE can be configured to switch the LCP setting back to the default LCP based on the occurrence of a condition (e.g., an implicit or explicit indication from the network).

If, however, the PUSCH opportunity used in step 808 is not the last PUSCH opportunity then the process can process to 814. At 814, the UE can process the next PUSCH opportunity associated with the same CG cycle and return to step 804.

Returning to step 806, if the buffer of LCH #X is not empty, the process can process to 816. At 816, the UE can continue to use the default LCP setting and generate a MAC PDU using data from LCH #X by multiplexing the data. The UE can then transmit the MAC PDU using the PUSCH opportunity. Upon transmitting the MAC PDU, the process can process to step 810.

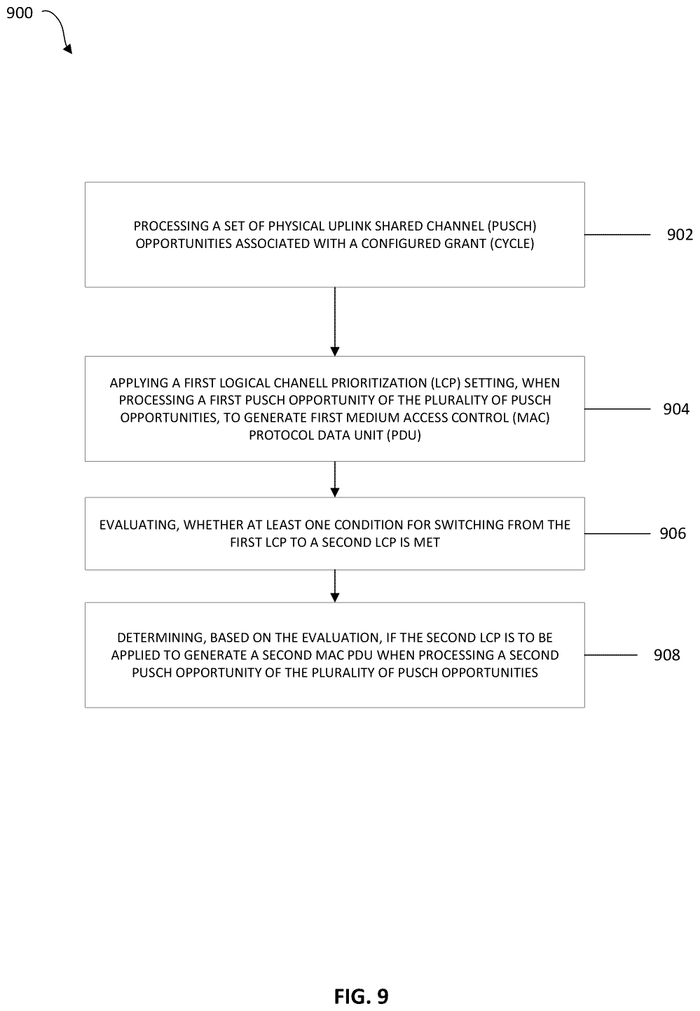

FIG. 9 is a process flow 900 for a UE selecting an LCP setting, according to one or more embodiments. At 902, the method can include, the UE processing a plurality of PUSCH opportunities associated with a CG cycle.

At 904, the method can include the UE applying a first LCP setting with a first PUSCH opportunity of a first subset of the plurality of PUSCH opportunities. The first LCP can be a default LCP setting that is fixed LCP and each PUSCH opportunity of the first subset can be associated with the fir LCP setting.

At 906, the method can include the UE evaluating, whether a condition is met to switch from the first LCP setting to a second LCP setting.

At 908, the method can include the UE determining, based on the evaluation, if a second LCP setting is to be applied to generate a second MAC PDU when processing a second PUSCH opportunity of the plurality of PUSCH opportunities. For example, the UE can detect that there are spare PUSCH opportunities after a UE has completed transmitting data for a particular LCH. The UE can then apply the second LCP setting for transmitting data from other different LCHs. The UE can then transmit the data using the second LCP setting.

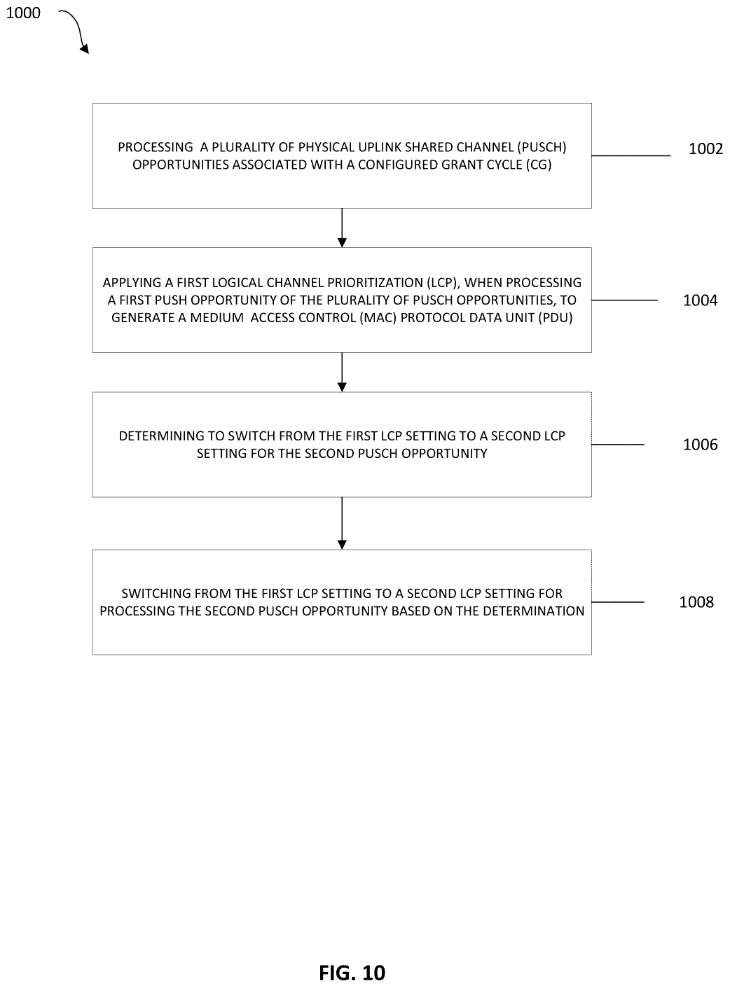

FIG. 10 is a process flow 1000 for a UE applying an LCP setting, according to one or more embodiments. At 1002, the method can include the UE processing a plurality of PUSCH opportunities associated with a CG cycle.

At 1004, the method can include the UE applying a first LCP setting when processing a first PUSCH opportunity of the plurality of PUSCH opportunities, to generate a MAC PDU. The first LCP can be a default LCP setting that is fixed LCP and each PUSCH opportunity of the first subset can be associated with the first LCP setting.

At 1006, the method can include the UE determining to switch from the first LCP setting to a second LCP setting for the second PUSCH opportunity. The determination can be based on one or more triggering conditions occurring . . . .

At 1008, the method can include switching from the first LCP setting to the second LCP setting for processing the second PUSCH opportunity based on the determination. The UE can then transmit the data using the second PUSCH opportunity and the second LCP setting.

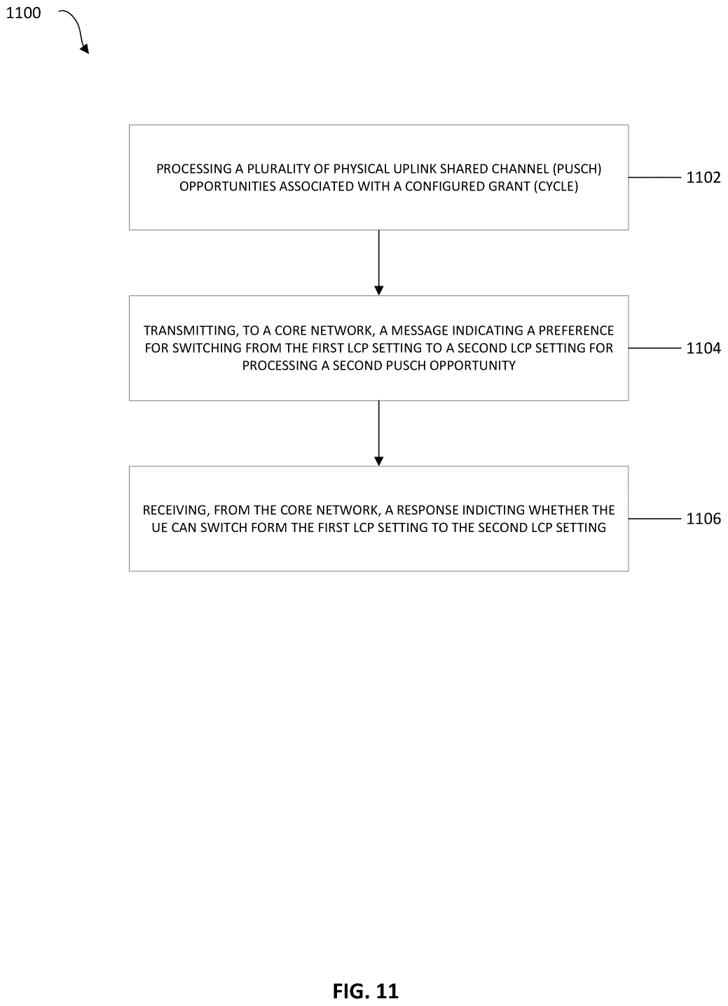

FIG. 11 is a process flow 1100 for a UE applying an LCP setting, according to one or more embodiments. At 1102 the method can include the UE processing a plurality of PUSCH opportunities associated with a CG cycle.

At 1104, the method can include the UE transmitting, to a core network, a message indicating a preference for switching from the first LCP setting to a second LCP setting for processing a second PUSCH opportunity.

At 1106, the method can include the UE receiving, from the core network, a response indicating whether the UE can switch from the first LCP setting to the second LCP setting.

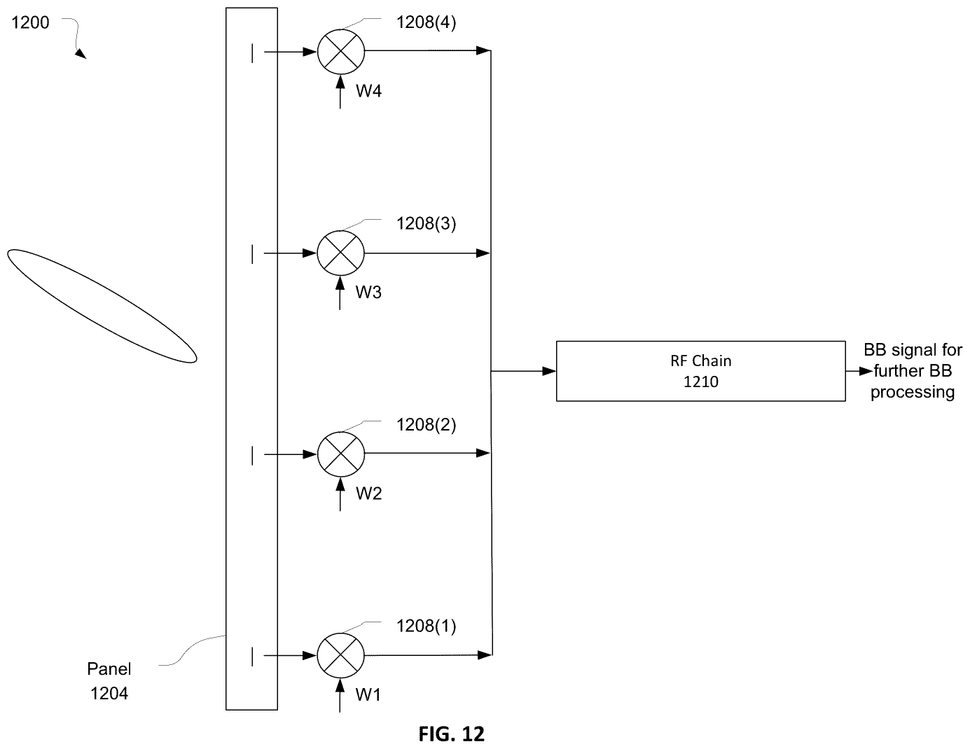

FIG. 12 illustrates receive components 1200 of the UE 1206, in accordance with some embodiments. The receive components 1200 may include an antenna panel 1204 that includes a number of antenna elements. The panel 1204 is shown with four antenna elements, but other embodiments may include other numbers.

The antenna panel 1204 may be coupled to analog beamforming (BF) components that include a number of phase shifters 1208(1)-1208(4). The phase shifters 1208(1)-1208(4) may be coupled with a radio-frequency (RF) chain 1212. The RF chain 1212 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1208(1)-1208(4) to provide a receive beam at the antenna panel 1204. These BF weights may be determined based on the channel-based beamforming.

FIG. 13 illustrates a UE 1300, in accordance with some embodiments. The UE 1300 may be similar to and substantially interchangeable with UE 1206 of FIG. 12.

Similar to that described above with respect to UE 1300, the UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1300 may include processors 1304, RF interface circuitry 1308, memory/storage 1312, user interface 1316, sensors 1320, driver circuitry 1322, power management integrated circuit (PMIC) 1324, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangements of the components shown may occur in other implementations.

The components of the UE 1300 may be coupled with various other components over one or more interconnects 1332, which may represent any type of interface, input/output, bus (local, system, or expansion), transmission line, trace, optical connection, etc. that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein.

In some embodiments, the baseband processor circuitry 1304A may access a communication protocol stack 1336 in the memory/storage 1312 to communicate over a 3GPP compatible network. In general, the baseband processor circuitry 1304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1312 may include any type of volatile or non-volatile memory that may be distributed throughout the UE 1300. In some embodiments, some of the memory/storage 1312 may be located on the processors 1304 themselves (for example, L1 and L2 cache), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and a radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1324 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1324.

In various embodiments, the RF interface circuitry 1308 may be configured to transmit/receive signals in a manner compatible with NR access technologies.

The antenna 1324 may include a number of antenna elements that each convert electrical signals into radio waves to travel through the air and to convert received radio waves into electrical signals. The antenna elements may be arranged into one or more antenna panels. The antenna 1324 may have antenna panels that are omnidirectional, directional, or a combination thereof to enable beamforming and multiple input, multiple output communications. The antenna 1324 may include microstrip antennas, printed antennas fabricated on the surface of one or more printed circuit boards, patch antennas, phased array antennas, etc. The antenna 1324 may have one or more panels designed for specific frequency bands including bands in FR1 or FR2.

The user interface circuitry 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1300.

The sensors 1320 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within, or connected to, the UE 1300. For example, driver circuitry 1322 may include a display driver to control and allow access to a display device, a touchscreen driver to control and allow access to a touchscreen interface, sensor drivers to obtain sensor readings of sensor circuitry 1320 and control and allow access to sensor circuitry 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

In some embodiments, the PMIC 1324 may control, or otherwise be part of, various power saving mechanisms of the UE 1300. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1300 may power down for brief intervals of time and thus save power. If there is no data traffic activity for an extended period of time, then the UE 1300 may transition off to an RRC_Idle state, where it disconnects from the network and does not perform operations such as channel quality feedback, handover, etc. The UE 1300 goes into a very low power state and it performs paging where again it periodically wakes up to listen to the network and then powers down again. The UE 1300 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1328 may power the UE 1300, although in some examples the UE 1300 may be mounted deployed in a fixed location, and may have a power supply coupled to an electrical grid. The battery 1328 may be a lithium ion battery, a metal-air battery, such as a zinc-air battery, an aluminum-air battery, a lithium-air battery, and the like. In some implementations, such as in vehicle-based applications, the battery 1328 may be a typical lead-acid automotive battery.

FIG. 14 illustrates a gNB 1400, in accordance with some embodiments. The gNB node 1400 may be similar to and substantially interchangeable with the base stations 144, 146 of FIG. 1.

The gNB 1400 may include processors 1404, RF interface circuitry 1408, core network (CN) interface circuitry 1412, and memory/storage circuitry 1416.

The components of the gNB 1400 may be coupled with various other components over one or more interconnects 1428.

The processors 1404, RF interface circuitry 1408, memory/storage circuitry 1416 (including communication protocol stack 1410), antenna 1424, and interconnects 1428 may be similar to like-named elements shown and described with respect to FIG. 12.

The CN interface circuitry 1412 may provide connectivity to a core network, for example, a 4th Generation Core network (5GC) using a 4GC-compatible network interface protocol such as carrier Ethernet protocols, or some other suitable protocol. Network connectivity may be provided to/from the gNB 1400 via a fiber optic or wireless backhaul. The CN interface circuitry 1412 may include one or more dedicated processors or FPGAs to communicate using one or more of the aforementioned protocols. In some implementations, the CN interface circuitry 1412 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further example embodiments are provided.

Example 1 includes a method, implemented by a UE, the method comprising: processing, a plurality of PUSCH opportunities associated with a CG cycle; applying, a first LCP setting when processing a first PUSCH opportunity of the plurality of PUSCH opportunities, to generate a first MAC protocol data unit (PDU); evaluating, whether at least one condition for switching from the first LCP setting to a second LCP setting is met; and determining, based on the evaluation, if the second LCP setting is to be applied to generate a second MAC PDU when processing a second PUSCH opportunity of the plurality of PUSCH opportunities.

Example 2 includes the method of example 1, wherein the first LCP setting includes a mapping restriction of a LCH, a priority of the LCH, a PBR of the LCH, or a (BSD) of the LCH.

Example 3 includes the method of example 1 or 2, wherein the LCH is configured with a radio resource control (RRC) parameter, and wherein the RRC parameter includes an allowed configured grant (AllowedCG) list.

Example 4 includes the method of examples 1-3, wherein the first LCP setting indicates that only a first LCH is allowed to be mapped to the CG, and wherein the second LCP setting indicates that the first LCH and a second LCH are allowed to be mapped to the CG.

Example 5 includes the method of examples 1-3, wherein the first LCP setting indicates that only a first LCH is allowed to be mapped to the CG, and wherein the second LCP setting indicates all LCHs are mapped to the CG.

Example 6 includes the method of examples 1-3, wherein the first LCP setting indicates that a priority of a first LCH is set to be higher than a priority of a second LCH, and wherein the second LCP setting indicates that the priority of the second LCH is set to be higher than the priority of the first LCH.

Example 7 includes the method of examples 1-6, wherein the first LCP setting is a default LCP setting.

Example 8 includes one or more computer-readable media having stored thereon a sequence of instructions which, when executed, causes a processor to perform operations including a method described in or related to examples 1-7.

Example 9 includes a device comprising memory; processing circuitry, coupled with the memory, to perform one or more elements of a method described in or related to examples 1-7.

Example 10 includes a method, implemented by a UE, the method comprising: processing a plurality of PUSCH opportunities associated with a multi-PUSCH DG cycle; applying a first LCP setting when processing a first PUSCH opportunity of the plurality of the plurality of PUSCH opportunities, to generate a first MAC PDU; evaluating, whether at least one condition is met for switching from the first LCP to a second LCP setting; and determining, based on the evaluation, if the second LCP setting is to be applied to generate a second MAC PDU when processing a second PUSCH opportunity of the plurality of PUSCH opportunities.

Example 11 includes the method of example 10, wherein the first LCP setting is a default LCP setting.

Example 12 includes one or more computer-readable media having stored thereon a sequence of instructions which, when executed, causes a processor to perform operations including a method described in or related to example 10 or 11.

Example 13 includes a device comprising memory; processing circuitry, coupled with the memory, to perform one or more elements of a method described in or related to examples 10-12.

Example 14 includes a UE, comprising: memory to store information related to a plurality of PUSCH opportunities; processing circuitry, coupled with the memory, to: process a plurality of PUSCH opportunities associated with a CG cycle; apply a first LCP setting when processing a first PUSCH opportunity of the plurality of PUSCH opportunities, to generate a medium access control MAC PDU; determine to switch from the first LCP setting to a second LCP setting for a second PUSCH opportunity; and switch from the first LCP setting to the second LCP setting for processing the second PUSCH opportunity based on the determination

Example 15 includes the UE of example 14, wherein the determination is based on a base station configuring the UE to apply the first LCP setting for the first PUSCH opportunity and to apply a second LCP setting for the second PUSCH opportunity.

Example 16 includes the UE of example 14, wherein the determination to switch from the first LCP setting to a second LCP setting for the second PUSCH opportunity is based on a buffer of a first LCH being empty.

Example 17 includes the UE of example 14, wherein the determination to switch from the first LCP setting to a second LCP setting for the second PUSCH opportunity is based on a buffer of a first LCH being empty for a threshold period of time.

Example 18 includes the UE of example 14, wherein the determination to switch from the first LCP setting to a second LCP setting for the second PUSCH opportunity is based on a buffer of a first LCH receiving data after being empty.

Example 19 includes the UE of example 14, wherein the determination to switch from the first LCP setting to a second LCP setting for the second PUSCH opportunity is based on a buffer storing less than a threshold amount of data.

Example 20 includes the UE of example 14, wherein the determination to switch from the first LCP setting to a second LCP setting for the second PUSCH opportunity is based on a buffer storing greater than a threshold amount of data.

Example 21 includes the UE of example 14, wherein the determination to switch from the first LCP setting to a second LCP setting for the second PUSCH opportunity is based on a time interval remaining on a data delivery deadline being less than a threshold amount of time

Example 22 includes the UE of example 14, wherein the determination to switch from the first LCP setting to a second LCP setting for the second PUSCH opportunity is based on a time interval remaining on a data delivery deadline being less than a threshold amount of time.

Example 23 includes the UE of example 14, wherein the determination to switch from the first LCP setting to a second LCP setting for the second PUSCH opportunity is based on a queuing time of an LCH exceeding a threshold.

Example 24 includes the UE of example 14, wherein the determination to switch from the first LCP setting to a second LCP setting for the second PUSCH opportunity is based on a data unit in an LCH buffer being in an important PDU set.

Example 25 includes the UE of example 14, wherein the determination to switch from the first LCP setting to a second LCP setting for the second PUSCH opportunity is based on no data unit in an LCH buffer being in an important PDU set

Example 26 includes the UE of example 14, wherein the CG cycle is a first CG cycle, and wherein the processing circuitry, coupled with the memory, further to determine to switch from the second LCP setting back to the first LCP setting for a PUSCH opportunity associated with a second CG cycle.

Example 27 includes the UE of example 14, wherein the determination to switch from the first LCP setting to a second LCP setting for the second PUSCH opportunity is based on an occurrence of a first condition, and wherein the processing circuitry, coupled with the memory, further to: determine that the first condition for switching from the first LCP setting to the second LCP setting is no longer applicable; and determine to switch from the second LCP setting back to the first LCP setting for processing a PUSCH opportunity associated with the CG cycle.

Example 28 includes the UE of example 14, wherein the determination to switch from the first LCP setting to a second LCP setting for the second PUSCH opportunity is based on an occurrence of a first condition, and wherein the processing circuitry, coupled with the memory, further to: determine that a condition for switching from the first LCP setting to the second LCP setting is no longer applicable; and determine to switch from the second LCP setting back to the first LCP setting for processing a PUSCH opportunity based on an occurrence of a second condition.

Example 29 includes the UE of example 14, wherein determining to switch from the first LCP setting to a second LCP setting for the second PUSCH opportunity is based on determining an occurrence of a condition, wherein determining the occurrence of the condition is performed prior to generating a medium access control protocol data unit (MAC PDU) to be transmitted during the second PUSCH opportunity.

Example 30 includes one or more computer-readable media having stored thereon a sequence of instructions which, when executed, causes a processor to perform operations including a method described in or related to example 14 or 29.

Example 31 includes a method, performed by a device, to perform one or more elements of the steps described in or related to examples 14-29.

Example 32 includes a UE, comprising: memory to store information related to a plurality of PUSCH opportunities; processing circuitry, coupled with the memory, to: process a plurality of PUSCH opportunities associated with a CG cycle; process a first PUSCH opportunity of the plurality of PUSCH opportunities, wherein a CG configuration of allocated resources is configured for a first logical channel prioritization (LCP) setting, the processing comprising: determining a first LCH buffer is empty; switching to a second LCP setting for processing the first PUSCH opportunity based on the determination that the LCH buffer is empty; and generating a medium access control MAC PDU for transmission using the first PUSCH opportunity based on the determination, the UE applying the second LCP setting for generating the MAC PDU.

Example 33 includes the UE of example 32, wherein the processing circuitry, coupled with the memory, further to: determine that the first PUSCH opportunity is a last PUSCH opportunity of the plurality of PUSCH opportunities associated with the CG cycle; and switch from the second LCP setting back to the first LCP for processing a second PUSCH opportunity setting based on the determination.

Example 34 includes the UE of example 32, wherein the processing circuitry, coupled with the memory, further to: determine that the first PUSCH opportunity is not a last PUSCH opportunity of the plurality of PUSCH opportunities associated with the CG cycle; and process a second PUSCH opportunity associated with the CG cycle applying the second LCP setting based on the determination.

Example 35 includes one or more computer-readable media having stored thereon a sequence of instructions which, when executed, causes a processor to perform operations including a method described in or related to example 32-34.

Example 36 includes a method, performed by a device, to perform one or more elements of the steps described in or related to examples 32-34.

Example 37 includes one or more non-transitory computer-readable media including stored thereon instructions that, when executed by one or more processors, cause a UE to: process a plurality of PUSCH opportunities associated with a CG cycle; transmit, to a core network, a message indicating a preference for switching from the first LCP setting to a second LCP setting for processing a second PUSCH opportunity; and receive, from the core network, a response indicating whether the UE can switch from the first LCP setting to the second LCP setting.

Example 38 includes one or more non-transitory computer-readable media of example 37, wherein the message is an RRC message.

Example 39 includes one or more non-transitory computer-readable media of example 37 or 38, wherein the message includes a MAC CE.

Example 40 includes one or more non-transitory computer-readable media of examples 37-39, wherein the CG allocates resources to a first LCH, wherein the CG does not allocate resources a second LCH, wherein the UE is configured to use the first LCH for any PUSCH opportunity of the plurality of PUSCH opportunities, wherein the UE is further configured to use the second LCH for any unused PUSCH opportunity of the plurality of PUSCH opportunities.

Example 41 includes one or more non-transitory computer-readable media of examples 37-40, wherein use of a PUSCH resource is based on a parameter satisfying a condition.

Example 42 includes one or more non-transitory computer-readable media of examples 37-41, wherein a the first LCH is configured to allow transmit data on the any unused PUSCH opportunity.

Example 43 includes a device comprising memory; processing circuitry, coupled with the memory, to perform one or more elements of a method described in or related to examples 37-42.

Example 44 includes a method, performed by a device, to perform one or more elements of the steps described in or related to examples 37-42.

Example 45 includes a base station, comprising: one or more processors; a communication interface; RF interface circuitry; and one or more computer-readable media including instructions that, when executed by the one or more processors, cause the base station to: receive, from a UE, a message indicating a preference for switching from a first LCP setting to a second LCP setting; and transmit, to the UE, a response message indicating that the UE is permitted to switch from the first LCP setting to the second LCP setting.

Example 46 includes the base station of example 45, wherein the message comprises assistance information.

Example 47 includes the base station of example 45 or 46, wherein the message is a RRC message or a MAC CE message.

Example 48 includes the base station of examples 45-47, wherein the response message further indicates that the UE is permitted switch from the first LCP setting to the second LCP setting using a control signal.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a plurality of physical uplink shared channel (PUSCH) opportunities associated with a configured grant (CG) cycle;
applying a first logical channel prioritization (LCP) setting, when processing a first PUSCH opportunity of the plurality of PUSCH opportunities, to generate a first medium access control (MAC) protocol data unit (PDU);
evaluating whether at least one condition for switching from the first LCP setting to a second LCP setting is met; and
determining, based on the evaluation, if the second LCP setting is to be applied to generate a second MAC PDU when processing a second PUSCH opportunity of the plurality of PUSCH opportunities.

2. The method of claim 1, wherein the first LCP setting includes a mapping restriction of a logical channel (LCH), a priority of the LCH, a prioritized bit rate (PBR) of the LCH, or a bucket size duration (BSD) of the LCH.

3. The method of claim 2, wherein the LCH is configured with a radio resource control (RRC) parameter, and wherein the RRC parameter includes an allowed configured grant (AllowedCG) list.

4. The method of claim 1, wherein the first LCP setting indicates that only a first LCH is allowed to be mapped to the CG, and wherein the second LCP setting indicates that the first LCH and a second LCH are allowed to be mapped to the CG.

5. The method of claim 1, wherein the first LCP setting indicates that only a first LCH is allowed to be mapped to the CG, and wherein the second LCP setting indicates all LCHs are mapped to the CG.

6. The method of claim 1, wherein the first LCP setting indicates that a priority of a first LCH is set to be higher than a priority of a second LCH, and wherein the second LCP setting indicates that the priority of the second LCH is set to be higher than the priority of the first LCH.

7. The method of claim 1, wherein the first LCP setting is a default LCP setting.

8. An apparatus comprising:
memory to store information related to a plurality of PUSCH opportunities;
processing circuitry, coupled with the memory, to:
process a plurality of PUSCH opportunities associated with a configured grant (CG) cycle;
apply a first logical channel prioritization (LCP) setting, when processing a first PUSCH opportunity of the plurality of PUSCH opportunities, to generate a medium access control (MAC) protocol data unit (PDU);
determine to switch from the first LCP setting to a second LCP setting for a second PUSCH opportunity; and
switch from the first LCP setting to the second LCP setting for processing the second PUSCH opportunity based on the determination.

9. The apparatus of claim 8, wherein the determination is based on a base station configuring the UE to apply the first LCP setting for the first PUSCH opportunity and to apply a second LCP setting for the second PUSCH opportunity.

10. The apparatus of claim 8, wherein the determination to switch from the first LCP setting to a second LCP setting for the second PUSCH opportunity is based on a buffer of a first LCH being empty.

11. The apparatus of claim 8, wherein the determination to switch from the first LCP setting to a second LCP setting for the second PUSCH opportunity is based on a buffer of a first LCH being empty for a threshold period of time.

12. The apparatus of claim 8, wherein the determination to switch from the first LCP setting to a second LCP setting for the second PUSCH opportunity is based on a buffer of a first LCH receiving data after being empty.

13. The apparatus of claim 8, wherein the determination to switch from the first LCP setting to a second LCP setting for the second PUSCH opportunity is based on a buffer storing less than a threshold amount of data.

14. The apparatus of claim 8, wherein the determination to switch from the first LCP setting to a second LCP setting for the second PUSCH opportunity is based on a buffer storing greater than a threshold amount of data.

15. One or more non-transitory computer-readable media including stored thereon instructions that, when executed, cause processing circuitry to:
process a plurality of physical uplink shared channel (PUSCH) opportunities associated with a configured grant (CG) cycle;
generate a message to be transmitted to a core network, the message to indicate a preference for switching from a first logical channel prioritization (LCP) setting to a second LCP setting for processing a second PUSCH opportunity; and
process a response received from the core network, the response to indicate whether the processing circuitry can switch from the first LCP setting to the second LCP setting.

16. The one or more non-transitory computer-readable media of claim 15, wherein the message is a radio resource control (RRC) message.

17. The one or more non-transitory computer-readable media of claim 15, wherein the message includes a medium access control (MAC) control element (CE).

18. The one or more non-transitory computer-readable media of claim 15, wherein the CG allocates resources to a first logical channel (LCH), wherein the CG does not allocate resources a second LCH, wherein the processing circuitry is configured to use the first LCH for any PUSCH opportunity of the plurality of PUSCH opportunities, wherein the processing circuitry is further configured to use the second LCH for any unused PUSCH opportunity of the plurality of PUSCH opportunities.

19. The one or more non-transitory computer-readable media of claim 18, wherein use of a PUSCH resource is based on a parameter satisfying a condition.

20. The one or more non-transitory computer-readable media of claim 18, wherein a the first LCH is configured to allow transmit data on the any unused PUSCH opportunity.
